(19) United States
(12) Patent Application Publication
(10) Pub. No.: US 2008/0209559 A1
(43) Pub. Date: Aug. 28, 2008

(54) Method for detecting that a protected software program is cracked

(75) Inventors: Michael Zunke, Kirchheim (DE); Yanki Margalit, Ramat Gan (IL); Dany Margalit, Ramat Gan (IL)

Correspondence Address: DARBY & DARBY P.C., P.O. BOX 770, Church Street Station, New York, NY, 10008-0770, US

(73) Assignee: Aladdin Knowledge Systems, Petach Tikva (IL)

(21) Appl. No.: 11/710,282

(22) Filed: Feb. 22, 2007

(51) Int. Cl. G06F 11/00

(52) U.S. Cl. 726/23

(57) ABSTRACT

A method for determining if a software program having a protective envelope has been cracked, and signaling an indication thereof. A direct determination is made of whether the protective envelope is intact or has been compromised by an attack, without requiring a license violation to occur. Executable code in the protective envelope generates an envelope confirmation which is validated by executable code in the program itself. Any disabling or separation of the envelope from the program will be detectable by the program at validation time. Provisions are made for a secure envelope confirmation, the use of arguments as input to the confirmation generation, and for incorporating information related to the computer and user to facilitate identifying the attacker. Signaled indications can include network messaging to alert the licensor that the program has been cracked.

### FIELD OF THE INVENTION

The present invention relates to protecting licensed computer software usage rights, and, in particular, to the detecting of tampering attacks on protected software.

### BACKGROUND OF THE INVENTION

A common way of enforcing a license regarding the usage rights of a software program (herein denoted as a “program”) is to furnish the program with executable code that regulates the usage of the program according to the terms and conditions under which the program is licensed to the user. Furnishing the program in such a manner is typically done by embedding the regulating executable code (herein denoted as “protective code”) into the program, or, equivalently, by packaging the program and the protective code together within a single computer file (herein denoted as a “file”). Such a program is said to be “protected” within a “protective envelope” (also denoted herein as an “envelope”) made up of the protective code. In addition to monitoring and regulating program usage according to the license, the protective code typically performs other functions related to software protection. For example, the program may be encrypted, and may be decrypted by the protective code only immediately before execution. The terms “executable code” and “code” are herein used synonymously and denote instructions, statements, commands, or other directives which may be executed or interpreted by a computer to perform data handling and data processing operations.

When the user runs a protected program by invoking the program's file on the computer, the protective code typically executes to perform initialization functions (such as decryption of the encrypted program, as noted previously). Thereafter, the protective code typically runs simultaneously with the program in the process background to monitor and regulate program usage according to the license terms. Typical license terms govern factors which may include, but are not limited to: the computer(s) on which the program can be run; the number of concurrent users; the time period(s) during which the program can be used; the number of times the program can be used; and the computer resources (e.g., file and network services) which the program can access.

Protected programs, however, are subject to attacks whose goals are to evade the license-regulating mechanisms. In one mode of attack, the attacker seeks to separate the program from the envelope in such a way that the protective code is removed, disabled, or bypassed. If the attack is successful, the program can be run in an unprotected fashion, without any regulation according to the license terms. The user can then operate the program contrary to the license agreement in an unauthorized manner. A program originally provided in an envelope but which has been successfully separated from the envelope in the above-described manner is commonly said to have been “cracked”; it is also commonly said that that protective envelope has been “cracked”—both expressions are taken to denote the same consequences for the program. In addition to allowing the attackers themselves to violate the license, the precise methods of cracking the program are often published in the form of executable code that disables the envelope. Moreover, cracked programs themselves are typically freely distributed, in further violation of the license agreement.

There has been considerable effort made to provide protective code that can withstand such attacks. U.S. Patent Application Publication 2005/0183072 of Homing, et al., titled “Software self-defense systems and methods” (herein denoted as “Horning”) provides an overview and survey of many details of cracking attacks and ways of defending the protective code against these attacks through the use of self-defensive programs (SDP's). Unfortunately, continuing advances and changes in technology render many of these techniques short-lived. Many of the methods and approaches of Homing, for example, rely on the ability of a running program to detect that it is being executed under the control of a debugger, and to interfere with the debugger—the presumption is that the attacker will use a debugger to analyze and disable the protective code, and if the protective code can detect this and take evasive action, the attack can be neutralized. Horning's reliance on this presumption, however, ignores the fact that many serious attackers use hardware debuggers which are independent of software and cannot be detected or influenced by the techniques Homing presents.

U.S. Pat. No. 6,463,538 to Elteto, titled “Method of software protection using a random code generator” (herein denoted as “Elteto”) implements a defensive technique to thwart cracking attacks on a protected program by randomizing each instance of the protected program so that the protective code will differ substantially from one instance to the next, making it effectively impossible for the attacker to develop (and publish) a crack that would succeed in general for all instances. In theory, Elteto's approach is valid, but in practice it fails to solve the problem, because an attacker need crack only a single instance of the protected program and then publish that cracked instance. Although publishing and distributing an entire program is more involved and cumbersome than publishing only the crack itself, the ever-increasing bandwidth of networks and the ease of network distribution, particularly over the Internet, ultimately make it just as feasible to publish the cracked program instance as it is to publish the crack itself.

The limitations on Horning as well as the failure of Elteto and similar approaches to prevent cracking has led some to conclude that there is no decisive solution to the cracking problem in the realm of self-defensive programs—that self-defensive programming techniques, while useful, can never be sufficient. For example, U.S. Patent Application 2006/0174346 of Carroll, et al. entitled “Instrumentation for alarming a software product” (herein denoted as “Carroll”) takes the approach that any software protection can ultimately be broken and discloses a scheme for signaling an alarm over the Internet when a software license is violated. The weakness of Carroll, however, is that there is no provision for directly determining that a protected software application has been cracked. Carroll can only indirectly infer that the program has been cracked by monitoring usage for license violations. There are two principal shortcomings on account of this restriction: First, not all license violations may be readily detectable. For example, an attacker might distribute unauthorized copies of a software program, none of which have means of detecting that they are unauthorized copies, and therefore cannot detect that there are any license violations. Secondly, a software license violation might possibly occur in the absence of any attack on the software's protective envelope, in which case the Carroll system would signal a false alarm.

There is thus a need for, and it would be highly advantageous to have, a means of directly determining if a protected software program has been cracked. This goal is met by the present invention.

### SUMMARY OF THE INVENTION

It is an objective of the present invention to directly determine if the protective envelope of a software program has been attacked, including, but not limited to: removal; modification; bypassing; and disabling.

According to embodiments of the present invention, the protective envelope is provided with executable code for generating a confirmation, which is written to computer memory (also denoted herein as “memory”). Additionally, the program itself is provided with executable code for validating the generated confirmation. The program is thus able to determine if the protective envelope is functioning properly by the results of the validation. In case of a failed validation, the program itself signals an indication that the protective envelope has been attacked, i.e., that the program has been cracked.

According to embodiments of the present invention, the envelope confirmation is generated according to a predetermined confirmation rule, such that validation can be effected in an accurate and timely manner.

Therefore, according to the present invention there is provided a method for detecting if a software program with a protective envelope is cracked, the method including: (a) providing computer memory for storing an envelope confirmation; (b) providing executable envelope confirmation generating code within the envelope, the envelope confirmation generating code operative to generate the envelope confirmation according to a predetermined envelope confirmation rule; (c) providing executable envelope confirmation validation code within the program, the envelope confirmation validation code operative to determine if the envelope confirmation conforms to the envelope confirmation rule; (d) executing the envelope confirmation generating code to generate the envelope confirmation according to the envelope confirmation rule, and storing the envelope confirmation in the computer memory; (e) executing the envelope confirmation validation code to determine if the envelope confirmation conforms to the envelope confirmation rule; (f) if the envelope confirmation does not conform to the envelope confirmation rule, then signaling an indication that the program is cracked; and (g) if the envelope confirmation does conform to the envelope confirmation rule, then repeating the executing envelope confirmation generating code and the executing envelope confirmation validation code.

### BRIEF DESCRIPTION OF THE DRAWINGS

The invention is herein described, by way of example only, with reference to the accompanying drawings, wherein:

FIG. 1 is a conceptual computer memory map of a prior art protected software program.

FIG. 2 is a conceptual computer memory map showing an envelope confirmation and validator according to embodiments of the present invention.

FIG. 3 is a flowchart showing the run-time operation of a method according to embodiments of the present invention.

### DESCRIPTION OF THE PREFERRED EMBODIMENTS

The principles and operation of a method according to the present invention for detecting that a protected software program is cracked, may be understood with reference to the drawings and the accompanying description.

### Additional Definitions

In addition to definitions of terms appearing elsewhere herein, there are the following term definitions:
“Envelope confirmation” (also denoted as a “confirmation”)—an item of information originated by a protective envelope, whose purpose is to confirm that the envelope exists and is operational. In the context of the present invention, an envelope confirmation is not necessarily secure. The term “secure confirmation” herein denotes a confirmation that is protected against impersonation through means known in the art, including, but not limited to: encryption; digital signatures; one-way functions; challenge-response; and passwords.
“Envelope confirmation generator” (also denoted as a “confirmation generator”)—an entity that generates an envelope confirmation. In particular, the term “envelope confirmation generating code” herein denotes executable code which functions as a confirmation generator, i.e., is operative to generate a confirmation.
“Envelope confirmation rule” (also denoted as a “confirmation rule” or a “rule”)—a predetermined specification that governs the format and/or content of an envelope confirmation. Envelope confirmation rules include, but are not limited to: mathematical functions; date and time functions; string functions; and data manipulations.
“Envelope confirmation validation” (also denoted as an “envelope validation” or a “validation”)—a step or process for determining that a particular item of information is an envelope confirmation and hence establishes that a protective envelope exists and is operational. Even if the envelope confirmation is not a secure confirmation, a validation is, in general, required to recognize the envelope confirmation as certifying that a protective envelope exists and is operational. According to embodiments of the present invention, validation of an envelope confirmation is performed by a program which is provided with a protective envelope. According to embodiments of the present invention, a validation has two possible mutually-exclusive outcomes:
   (1) either the validation establishes that the envelope confirmation conforms to the predetermined envelope confirmation rule (herein denoted as a “successful validation”); or
   (2) the validation establishes that the envelope confirmation does not conform to the predetermined envelope confirmation rule (herein denoted as a “failed validation”).
“Envelope confirmation validator” (also denoted as a “confirmation validator” or “validator”)—an entity that performs an envelope validation. The term “envelope confirmation validation code” (also denoted as “envelope validation code”) herein denotes executable code which functions as a validator, i.e., is operative to perform a validation.

The term “computer” herein denotes any device or apparatus capable of executing data processing instructions, including, but not limited to: personal computers; mainframe computers; servers; workstations; data processing systems and clusters; networks and network gateways, routers, switches, hubs, and nodes; embedded systems; processors, terminals; personal digital appliances (PDA); controllers; communications and telephonic devices; and memory devices, storage devices, interface devices, smart cards and tags, security devices, and security tokens having data processing and/or programmable capabilities. The term “running” in the context of executable software loaded on a computer herein denotes that the software is executing within a process of the computer, including, but not limited to, a background process.

### Method Operation

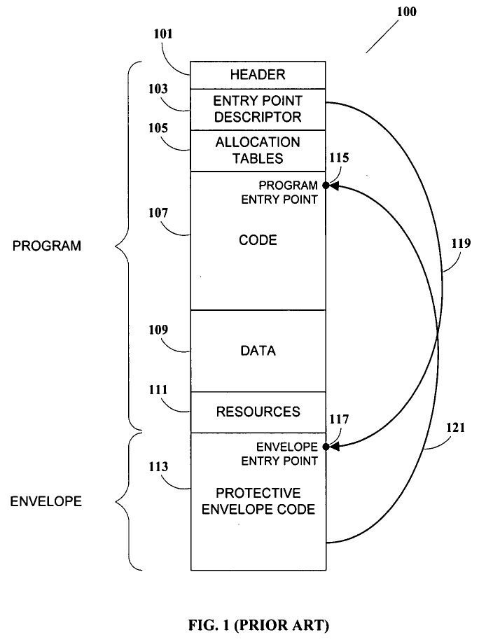

FIG. 1 is a conceptual computer memory map of a prior art protected software program 100, having a program header 101, an entry point descriptor 103, allocation tables 105, a code section 107, a data section 109, and resources 111. In code section 107 there is a program entry point 115, where the code initiating program operation is located. Program 100 is protected by protective envelope code 113, which has an envelope entry point 117, where the code initiating envelope operation is located. When protected program 100 is launched, entry point descriptor specifies a jump 119 to envelope entry point 115 to begin execution of protective envelope code 113. After protective envelope code 113 initializes, a jump 121 is made to program entry point 115 to begin regular program operation.

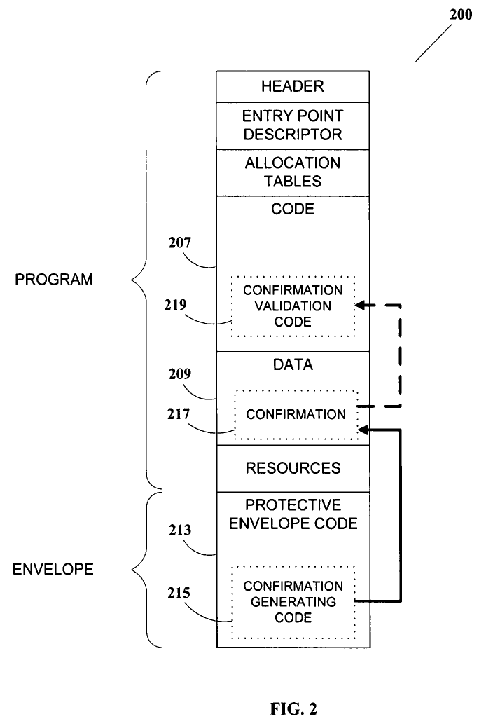

FIG. 2 is a conceptual computer memory map of a protected software program 200 according to embodiments of the present invention. Protective envelope code 213 contains confirmation generating code 215, which generates a confirmation 217 in computer memory. A code section 207 contains confirmation validation code 219, which validates confirmation 217.

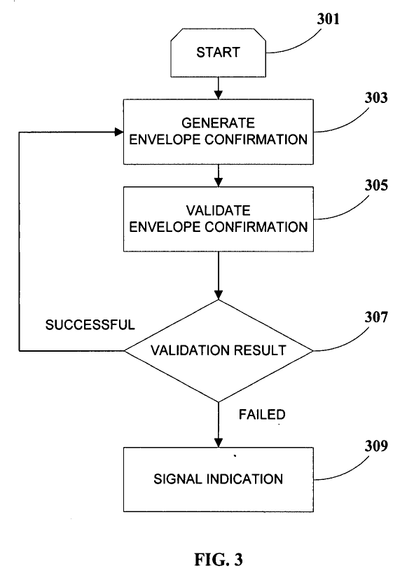

FIG. 3 is a flowchart showing the run-time operation of a method according to embodiments of the present invention. After a start point 301, an envelope confirmation (confirmation 217 in FIG. 2) is generated in a step 303 by confirmation generating code 215 (FIG. 2). Next, in a step 305, the confirmation is validated by confirmation validation code 219 (FIG. 2). At a decision point 307, the results of the validation are evaluated. If the validation is successful, the process continues by repeating envelope confirmation generation step 303. If the validation has failed, however, the process signals an indication in a step 309.

In an embodiment of the present invention, confirmation 217 is written into program memory. In another embodiment of the present invention, confirmation 217 is written into a data section 209, as shown in FIG. 2. In other embodiments of the present invention, confirmation 217 can be written into other areas of computer memory that are accessible to both confirmation generating code 215 and confirmation validation code 219. In still further embodiments of the present invention, confirmation 217 is written to a memory storage area of the computer, including, but not limited to an operating system registry storage. In the present context, memory storage areas of the computer are considered to be “computer memory”, and are denoted as such, even if the storage areas are contained in devices such as disk drives.

In additional embodiments of the present invention, the envelope confirmation includes a data variable of the program. In this fashion, the envelope confirmation may be conveniently hidden from potential attackers, who typically preserve all data variables of the program intact so as to insure proper program operation.

### Confirmation Rules

In order to achieve efficient and accurate validation, embodiments of the present invention provide for a confirmation to be generated according to a predetermined rule. In this manner, a validator for the confirmation attempts to verify that the confirmation was generated according to the predetermined rule, and the decision of whether the validation was a successful validation or a failed validation is based on whether or not the confirmation agrees with the predetermined rule.

In a non-limiting embodiment of the present invention, the confirmation is based on a time-stamp; in a related embodiment, the confirmation includes a time-stamp. In this embodiment, the confirmation generating code periodically writes a time-stamp as the confirmation. The term “time-stamp” herein denotes recorded information containing the calendar date and clock time (for example, the local date and clock time) in a predetermined format and with a predetermined resolution, and which was current to a reasonable degree of accuracy at the time of the creation and recording of the information. Non-limiting examples of time-stamps conforming to the foregoing definition and suitable for use in embodiments of the present invention are found in the Internet Society's published document RFC 3161 Internet X.509 Public Key Infrastructure Time-Stamp Protocol (TSP). According to embodiments of the present invention, the confirmation validation code compares the confirmation to the actual time, and if the confirmation is sufficiently close to the actual time (within a predetermined interval, for example), then the confirmation is deemed to have been successfully validated. If the confirmation is missing or significantly out-of-date (outside of the predetermined interval, for example), then the confirmation is deemed to have a failed validation.

Including Computer and User Information within the Envelope Confirmation

In an embodiment of the present invention, information about the computer and/or the user is included within the envelope confirmation, including, but not limited to: data related to the configuration of the computer; a network address of the computer, machine name, MAC address, hard drive serial number; and personal data related to the user of the computer, including username. In related embodiment, a function of this information is included within the envelope confirmation. Such a function may be a cryptographic function of the information.

In many cases, an attacker outputs a memory dump of an executing program to a file in order to crack the program. This is advantageous to the attacker, because doing so may allow capture of the decrypted (and operational) executable code of an encrypted program without having to break the encryption itself (the protective envelope does the decryption before loading the image into computer memory). However, by including information about the computer and the user, as described above, the attacker may unknowingly also dump information about himself and his computer into the output file, especially if the information is encrypted so that the attacker cannot easily determine that such information about him and his computer is in the output file. Therefore, by examining the cracked file, extracting the computer-related data from the envelope confirmation, and analyzing the computer-related data (using the appropriate decryption keys, as necessary), it may be possible for the licensor to gain information about the identity of the computer and/or the attacker himself, to aid in enforcement of the license.

Further information regarding providing information related to an attacker involved in an attack on protected software is disclosed in the co-pending US patent application of the present inventors entitled “Self-defensive protected software with suspended latent license enforcement”, which was filed simultaneously with the present application.

### Interrupt-Driven Confirmation Generation and Validation

An embodiment of the present invention provides for triggering the generation of a confirmation and the validation thereof via an interrupt, including, but not limited to a software interrupt. According to this embodiment, the interrupt insures that confirmation generation and validation are performed frequently and in a timely manner. In a related embodiment of the present invention, the interrupt is initiated periodically, based on a predetermined time-interval. For example, a repeating interrupt could be triggered every ten seconds to generate and validate a confirmation. In this case, a time-stamp-based confirmation would have to be within ten seconds of the actual time in order to achieve a successful validation.

### Confirmation Rule Argument

In an embodiment of the present invention, the validation code supplies a data argument to the confirmation generating rule. In a non-limiting example, the validation code supplies a random number as an argument, and the envelope confirmation rule is a predetermined function of the argument. The validator in turn attempts to verify that the confirmation is the predetermined function of the supplied argument. In order to do this, additional computer memory accessible to both the program and to the protective envelope is provided for storing the argument, and argument-generating code is also provided to the program, by which an argument is generated according to a predetermined rule. The argument-generating code is executed to generate the argument, which is subsequently used as an input to the envelope confirmation-generating code when generating the envelope confirmation. In a further embodiment of the present invention, the envelope confirmation rule includes a one-way function of the envelope confirmation argument. This increases the security of the envelope confirmation by making it difficult to deduce the argument from the confirmation.

### Secure Confirmation

Certain embodiments of the present invention provide for increased security of the confirmation. In an embodiment of the present invention, the confirmation is encrypted, and validation includes decrypting the confirmation. Note that this is in addition to having the protective envelope decrypt an encrypted program. In another embodiment of the present invention, the confirmation is signed according to a digital signature scheme, and the validation includes verifying the digital signature. Further embodiments of the present invention provide for one or more passwords and a challenge-response mechanism.

In order to implement a secure envelope confirmation, embodiments of the present invention provide for including a function of a random number and/or a counter in the envelope confirmation.

Signaling an Indication that the Program is Cracked

The present invention provides a variety of signals to indicate a cracked program. In an embodiment of the present invention, if the program detects that the protective envelope has been cracked, then a data value is set in the computer. Another program or entity can inspect the data value to determine if the program has been cracked. In another embodiment of the present invention, an output of display data is made on the computer. A non-limiting example of this embodiment is the display of a visual warning notification to the user. In addition to notifying the user that the program is being used in violation of the license agreement, the display data may also warn the user that the integrity of the program is no longer assured and that there may be a risk of virus infection as well.

In another embodiment of the present invention, the program may send a message that the protective envelope has been cracked. This message may be sent via the operating system to another program (e.g., a license manager, which could take further action to enforce the license). In yet another embodiment, the message is sent from the computer to another computer (e.g., a license server, which could take further action to enforce the license). In a further embodiment, the message is sent over a network, including, but not limited to the Internet (e.g., to the licensor who licenses the program, for taking further action to enforce the license).

In still another embodiment of the present invention, the message includes at least a part of the envelope confirmation itself—even if the validation indicates that the envelope confirmation does not conform to the predetermined envelope confirmation rule. In cases where the envelope confirmation contains information about the computer and the user, this may reveal information related to the identity of the attacker (as detailed above). When sent as a message to the program licensor, such information may aid in license enforcement.

### Configurations

In a preferred embodiment of the present invention, the executable code for generating and validating the envelope confirmation all execute on the same computer on which the protected program is loaded and running. In another embodiment, the executable code for generating the envelope confirmation and/or the executable code for validating the confirmation execute on an external computer which is connected to, and which is different from, the computer on which the protected program is loaded and running. In this other embodiment, the external computer can be a device having data processing and/or programmable capabilities, including, but not limited to a security device or token, or a licensing device or token.

### Computer Program Product

A further embodiment of the present invention provides a computer program product for performing the foregoing method or any variant derived therefrom. A computer program product according to this embodiment includes a set of executable commands for a computer, and is incorporated within machine-readable media including, but not limited to: magnetic media; optical media; computer memory; semiconductor memory storage; flash memory storage; and a computer network. The terms “perform”, “performing”, etc., and “run”, “running”, when used with reference to a computer program product herein denote the action of a computer when executing the computer program product, as if the computer program product were performing the actions. The term “computer” herein denotes any data processing apparatus capable of, or configured for, executing the set of executable commands to perform the foregoing method, including, but not limited to the devices as previously described as denoted by the term “computer”.

While the invention has been described with respect to a limited number of embodiments, it will be appreciated that many variations, modifications and other applications of the invention may be made.

1. A method for detecting if a software program with a protective envelope is cracked, the method comprising:
providing computer memory for storing an envelope confirmation;
providing executable envelope confirmation generating code within the envelope, said envelope confirmation generating code operative to generate said envelope confirmation according to a predetermined envelope confirmation rule;
providing executable envelope confirmation validation code within the program, said envelope confirmation validation code operative to determine if said envelope confirmation conforms to said envelope confirmation rule;
executing said envelope confirmation generating code to generate said envelope confirmation according to said envelope confirmation rule, and storing said envelope confirmation in said computer memory;
executing said envelope confirmation validation code to determine if said envelope confirmation conforms to said envelope confirmation rule;
if said envelope confirmation does not conform to said envelope confirmation rule, then signaling an indication that the program is cracked; and
if said envelope confirmation does conform to said envelope confirmation rule, then repeating said executing envelope confirmation generating code and said executing envelope confirmation validation code.

2. The method of claim 1, wherein the software program is loaded on a computer, and both of said executable envelope confirmation generating code and said envelope confirmation validation code are executed by the same said computer wherein the software program is loaded.

3. The method of claim 1, wherein said computer memory is selected from the group consisting of: program memory; a data section; and an operating system registry storage.

4. The method of claim 1, wherein the program is encrypted and the protective envelope is operative to decrypt the program.

5. The method of claim 1, wherein said signaling an indication comprises setting a data value in the computer.

6. The method of claim 1, wherein said indication comprises output of display data on the computer.

7. The method of claim 1, wherein said signaling comprises sending a message from the program.

8. The method of claim 7, wherein said message comprises at least part of said envelope confirmation.

9. The method of claim 8, wherein said envelope confirmation further comprises a function of data related to the computer, selected from the group consisting of:
data related to the configuration of the computer;
a network address of the computer;
machine name;
MAC address;
hard drive serial number;
username; and
personal data related to a user of the computer.

10. The method of claim 9, further comprising:
extracting said data related to the computer from said envelope confirmation; and
analyzing said data related to the computer to obtain information about at least one of: the computer; and said user of the computer.

11. The method of claim 7, wherein said message is sent from the computer.

12. The method of claim 11, wherein said message is sent over a network.

13. The method of claim 1, wherein said envelope confirmation is a secure confirmation.

14. The method of claim 13, wherein said secure confirmation is secured by a means selected from the group consisting of:
encryption;
a digital signature;
a challenge-response;
a password.

15. The method of claim 1, wherein said envelope confirmation rule comprises a function of time.

16. The method of claim 15, wherein said function of time comprises a time-stamp.

17. The method of claim 15, wherein said function of time is a function of local time.

18. The method of claim 1, wherein said envelope confirmation comprises a data variable.

19. The method of claim 1, wherein said data variable comprises a function of a random number.

20. The method of claim 1, wherein said data variable comprises a counter.

21. The method of claim 1, wherein at least one of said executing envelope confirmation generating code and said executing envelope confirmation validation code is initiated by an interrupt.

22. The method of claim 21, wherein said interrupt is based on a time interval.

23. The method of claim 1, further comprising:
providing additional computer memory for storing an envelope confirmation argument;
providing executable envelope confirmation argument generating code within the program, said envelope confirmation argument generating code operative to generate said envelope confirmation argument according to a predetermined envelope confirmation argument rule;
executing said envelope confirmation argument generating code to generate said envelope confirmation argument according to said envelope confirmation argument rule, and storing said envelope confirmation argument in said additional computer memory; and
using said envelope confirmation argument as an input to said envelope confirmation generating code.

24. The method of claim 23, wherein said envelope confirmation rule comprises a one-way function of said envelope confirmation argument.

25. A computer program product operative to perform the method of claim 1.
